(19) United States
(12) Patent Application Publication
(10) Pub. No.: US 2007/0214607 A1
(43) Pub. Date: Sep. 20, 2007

(54) Bendable handle

(75) Inventor: Jack Lin, Nantou County (TW)

Correspondence Address: BANGER SHIA, 204 CANYON CREEK, VICTORIA, TX, 77901-3695, US

(73) Assignee: Yih Cheng Factory Co., Ltd.

(21) Appl. No.: 11/375,317

(22) Filed: Mar. 14, 2006

(51) Int. Cl. E05B 1/00

(52) U.S. Cl. 16/438

(57) ABSTRACT

A bendable handle includes a grip, a shaft and a controlling device between the shaft and the grip. The grip includes an ear defining an aperture and a number of grooves in communication with the aperture. The shaft includes at least one ear defining an aperture and two grooves in communication with the aperture thereof. The controlling device includes a button, two guides on the button and two latches on the button. The guides are movably positioned in the grooves of the ear of the shaft. The latches are movably positioned in selective two of the grooves of the ear of the grip. The angle between the shaft and the grip is retained when the latches are positioned in selective two of the grooves of the ear of the grip. The angle between the shaft and the grip can be changed when the latches are moved from the grooves of the ear of the grip.

### BACKGROUND OF INVENTION

1. Field of Invention

The present invention relates to a bendable handle and, more particularly, to a bendable handle including a grip, a shaft and a controlling device between the shaft and the grip so that the bendable handle is made with a simple structure at a low cost and can easily be bent and held in shape.

2. Related Prior Art

A tool such as a screwdriver, a saw, a wrench, a pair of pliers and a pair of scissors includes one or two handles. A conventional handle is a rectilinear and provided with a soft skid-proof grip that can be held with comfort and ease. To optimize the maximum friction between a user's hand and the grip, the grip is often made as a polyhedron and formed with a skid-proof pattern. People can only provide torques under a certain value to the rectilinear handle no matter how they improve the grip.

To overcome the foregoing problem, there has been devised a handle connected with a crossbar that enables a user to provide a large torque to the handle.

Alternatively, there has been devised bendable handles that enables a user to provide a large torque thereto. An example of such bendable handles is found in Taiwanese Patent Publication No. 454650. These bendable handles are complicated in structure, week in strength, difficult in changing the angle thereof or inconvenient in operation.

The present invention is therefore intended to obviate or at least alleviate the problems encountered in prior art.

### SUMMARY OF INVENTION

It is an objective of the present invention to provide a bendable handle that can easily be bent and retained in shape.

It is another objective of the present invention to provide a bendable handle that includes a simple structure.

According to the present invention, a bendable handle includes a grip, a shaft and a controlling device between the shaft and the grip. The grip includes an ear defining an aperture and a number of grooves in communication with the aperture. The shaft includes at least one ear defining an aperture and two grooves in communication with the aperture thereof. The controlling device includes a button, two guides on the button and two latches on the button. The guides are movably positioned in the grooves of the ear of the shaft. The latches are movably positioned in selective two of the grooves of the ear of the grip. The angle between the shaft and the grip is retained when the latches are positioned in selective two of the grooves of the ear of the grip. The angle between the shaft and the grip can be changed when the latches are moved from the grooves of the ear of the grip.

Other objectives, advantages and features of the present invention will become apparent from the following description referring to the attached drawings.

### BRIEF DESCRIPTION OF DRAWINGS

The present invention will be described through detailed illustration of the preferred embodiment referring to the drawings.

FIG. 1 is an exploded view of a bendable handle according to the preferred embodiment of the present invention.

FIG. 2 is a perspective view of the bendable handle shown in FIG. 1.

FIG. 3 is a cross-sectional partial view of the bendable handle shown in FIG. 2.

FIG. 4 is another cross-sectional partial view of the bendable handle shown in FIG. 3.

FIG. 5 is a cross-sectional partial view of the bendable handle in another position than shown in FIG. 3.

FIG. 6 is another cross-sectional partial view of the bendable handle shown in FIG. 5.

### DETAILED DESCRIPTION OF PREFERRED EMBODIMENT

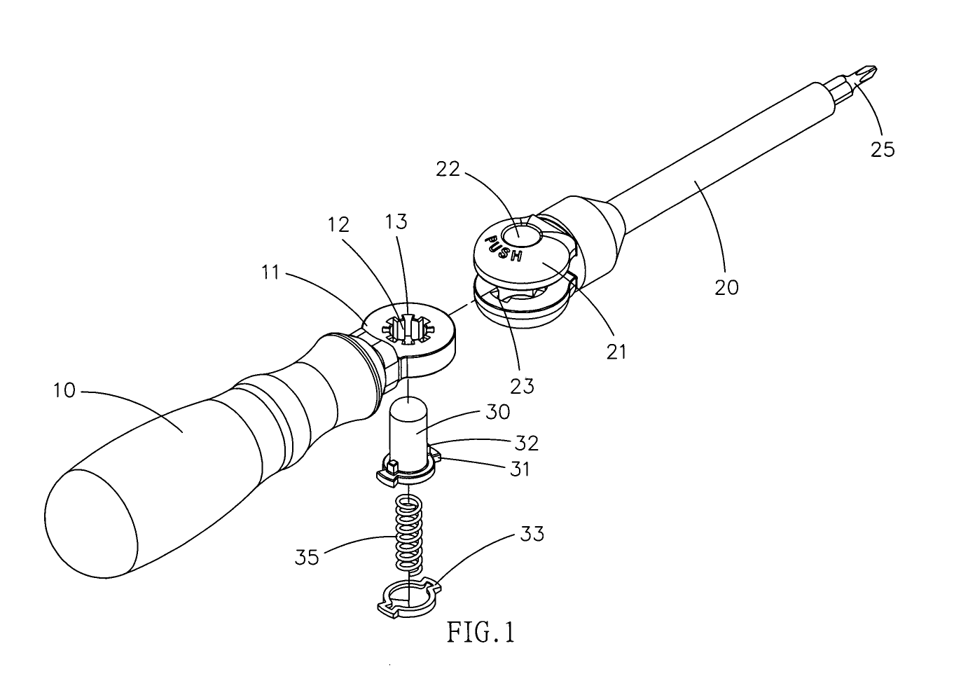

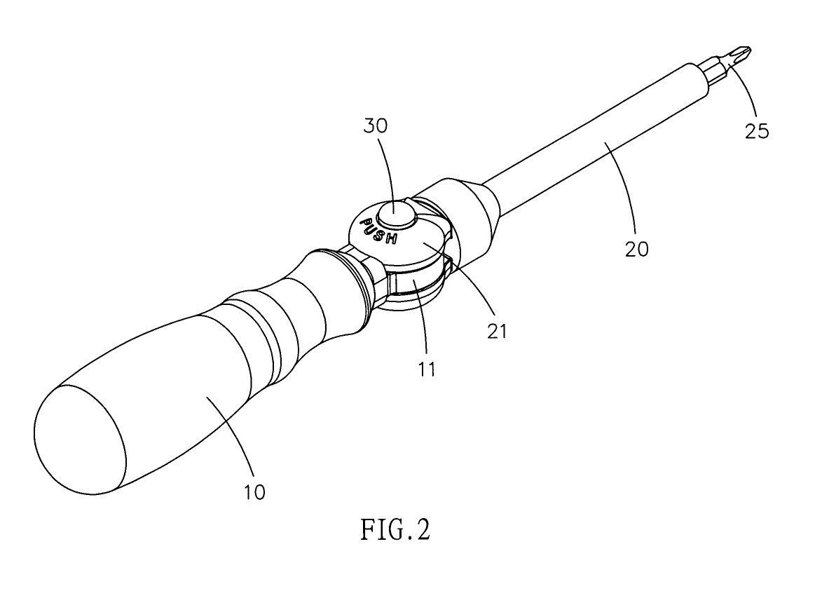

Referring to FIGS. 1 and 2, there is shown a bendable handle with a grip 10, a shaft 20 and a controlling device between the grip 10 and the shaft 20. The bendable handle can be used in various tools such as a screwdriver.

The grip 10 includes an ear 11 defining an aperture 12 and a number of grooves 13 evenly distributed on the wall of the aperture 12.

The shaft 20 includes a screwdriver bit 25 at an end and two ears 21 at an opposite end. Each of the ears 21 of the shaft 20 defines an aperture 22 corresponding to the aperture 12 of the ear 11 of the grip 10. One of the ears 21 of the shaft 20 defines two grooves 23 on the wall of the aperture 22 thereof. Positioned between the ears 21 of the shaft 20 is the ear 11 of the grip 10.

The controlling device includes a button 30, a spring 35 and a cap 33. The button 30 is movably positioned is the apertures 12 and 22 of the ears 11 and 21 of the grip 10 and the shaft 20. Two latches 32 and two guides 31 are formed on the button 30. The latches 32 can be positioned in selective two of the grooves 13. The guides 31 are movably positioned in the grooves 23. The spring 35 is compressed between the button 30 and the cap 33 fit in the aperture 22 and grooves 23 of one of the ears 21 of the shaft 20.

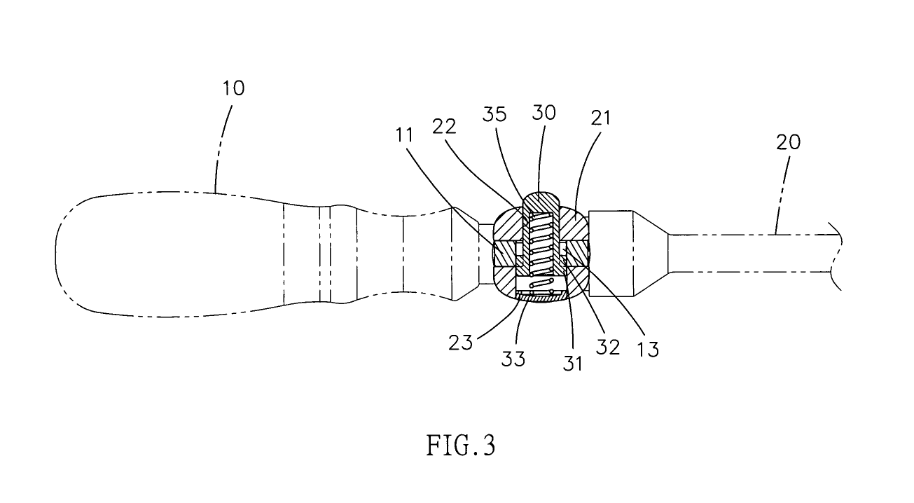

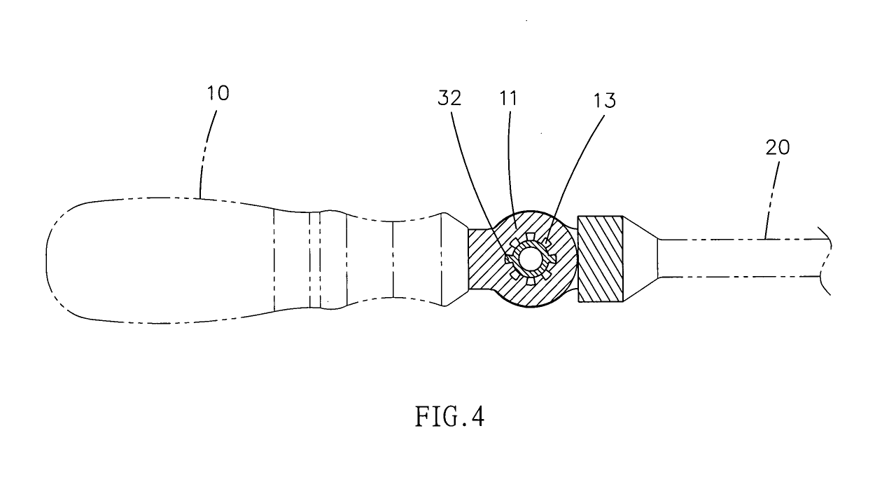

Referring to FIGS. 3 and 4, because of the spring 35, the controlling device is positioned in a locking position. The latches 32 are positioned in selective two of the grooves 13 of the ear 11 of the grip 10 while the guides 31 are in the grooves 23 of one of the ears 21 of the shaft 20. Therefore, the angle between the grip 10 and the shaft 20 is retained.

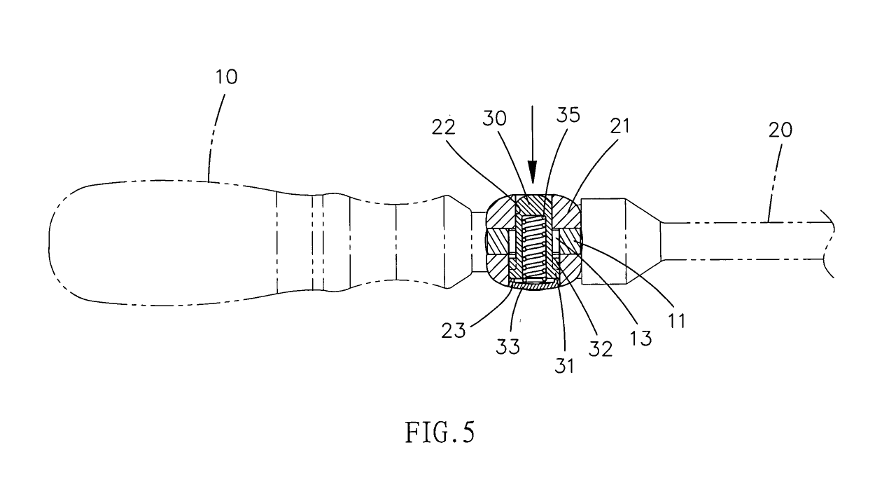

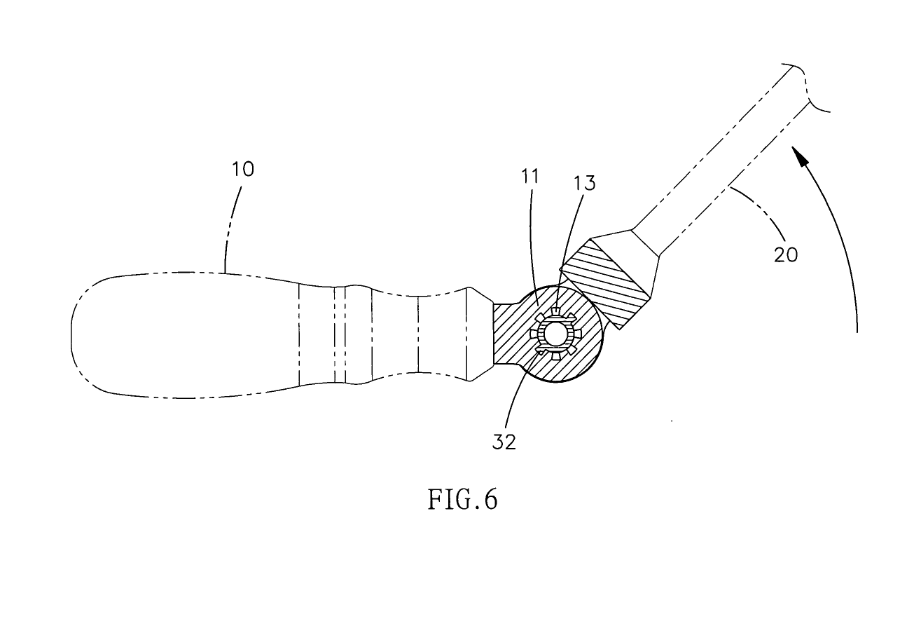

Referring to FIGS. 5 and 6, the button 30 is pushed so that the controlling device is moved to a releasing position. The latches 32 are moved from the grooves 13 of the ear 11 of the grip 10. Therefore, the angle between the grip 10 and the shaft 20 can be changed.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

1. A bendable handle comprising:
a grip comprising an ear defining an aperture and a number of grooves in communication with the aperture;
a shaft comprising at least one ear defining an aperture and two grooves in communication with the aperture thereof;
a controlling device comprising a button, two guides formed on the button and movably positioned in the grooves of the ear of the shaft and two latches formed on the button and movably positioned in selective two of the grooves of the ear of the grip so that the angle between the shaft and the grip is retained when the latches are positioned in selective two of the grooves of the ear of the grip and that the angle between the shaft and the grip can be changed when the latches are moved from the grooves of the ear of the grip.

2. The bendable handle according to claim 1 wherein the controlling device comprises a spring for biasing the button so as to push the latches into selective two of the grooves of the ear of the grip.

3. The bendable handle according to claim 2 wherein the controlling device comprises a cap fit in the aperture and grooves of the ear of the shaft so as to cover the spring.

4. The bendable handle according to claim 1 wherein the shaft comprises another ear, wherein the ear of the grip is positioned between the ears of the shaft.
